(19) United States
(12) Patent Application Publication
(10) Pub. No.: US 2014/0239906 A1
(43) Pub. Date: Aug. 28, 2014

(54) REDOX-ACTIVE LIGAND-BASED TRANSITION METAL COMPLEX FLOW BATTERIES

(71) Applicant: Sandia Corporation, Albuquerque, NM (US)

(72) Inventors: Travis Mark Anderson, Albuquerque, NM (US); Mitchell Anstey, Oakland, CA (US); Neil C. Tomson, Santa Fe, NM (US)

(73) Assignee: Sandia Corporation, Albuquerque, NM (US)

(21) Appl. No.: 14/189,830

(22) Filed: Feb. 25, 2014

Related U.S. Application Data
(60) Provisional application No. 61/770,918, filed on Feb. 28, 2013.

(51) Int. Cl. H01M 8/18; H02J 7/00; H01M 8/20

(52) U.S. Cl. CPC H01M 8/188; H01M 8/20; H02J 7/0068; H01M 2300/0025
USPC 320/128; 556/42; 429/105; 429/108

(57) ABSTRACT

Flow batteries including one or more metals complexed by one or more redox-active ligands are disclosed herein. In a general embodiment, the flow battery includes an electrochemical cell having an anode portion, a cathode portion and a separator disposed between the anode portion and the cathode portion. Each of the anode portion and the cathode portion includes one or more metals complexed by one or more redox-active ligands. The flow battery further includes an anode electrode disposed in the anode portion and a cathode electrode disposed in the cathode portion.

### RELATED APPLICATION

This application claims priority to U.S. Provisional Application No. 61/770,918, filed Feb. 28, 2013, and entitled “REDOX-ACTIVE LIGAND-BASED TRANSITION METAL COMPLEX FLOW BATTERIES”, the entirety of which is incorporated herein by reference.

### GOVERNMENT RIGHTS

This invention was made with Government support under Contract No. DE-AC04-94AL85000 between Sandia Corporation and the U.S. Department of Energy. The Government has certain rights in the invention.

### BACKGROUND

Global energy consumption is projected to increase at least two-fold by mid-century, and this increased need will be met, at least in part, through the use of renewable energy sources. Due to the intermittent nature of these resources, large-scale energy storage sources must likewise be invented, developed, and deployed in this timeframe in order for these carbon neutral technologies to be fully utilized and to aid in controlling CO₂ emissions. The need for grid storage is also being driven by the evolving nature of the grid (smart grid, green grid, and the distributed nature of the grid) as well as by other technological developments, such as vehicle electrification. Technologies that have been explored for various energy storage applications include pumped hydroelectricity (PHE), compressed air (CAES), batteries, flywheels, and ultracapacitors. Among the technologies that are not geographically constrained, flow batteries show promise in terms of power rating (MW), response time, capital cost, and cycle life at 80 percent depth of discharge.

Broadly defined, a flow battery is an energy storage technology that utilizes reduction-oxidation (redox) states of various species for charge and discharge purposes. During the charge of a redox flow battery (RFB), electro-active material is pumped from an external reservoir, through an electrochemical cell, into a second external reservoir. Charge is stored in the form of chemical energy through changes in the charge state of the active material. Discharge occurs by reversing the process. Flow batteries are unique among charge storage devices because some designs can completely decouple power and energy.

The earliest flow battery designed was an iron-chromium battery. This battery contains aqueous chromium and iron solutions for the cathode and anode, respectively, and it has an open circuit potential of 1.2 V. Despite the low cost of the materials, this battery displays significant crossover of the electro-active species and thus significantly reduced capacity. In addition, the chromium redox reactions are sluggish and require a catalyst for reasonable performance. In order to mitigate crossover issues, an all-vanadium battery was developed with aqueous vanadium solutions for both the cathode and the anode. In the cathode, the vanadium cycles between the +5 and +4 oxidation states, and in the anode it cycles between +3 and +2. Like the iron-chromium chemistry, the all-vanadium battery has very low energy density due to the limited solubility of the electro-active material. In addition, the cathode displays significant temperature sensitivity that requires extensive thermal management. A promising aqueous flow battery in terms of energy density is the zinc-bromine system. However, a number of issues are still present with this chemistry, including bromine toxicity, zinc dendrite formation, and high self-discharge. As a result, there is a need for improved and more efficient flow batteries.

### SUMMARY

In a general embodiment, the present disclosure provides a flow battery including one or more metal complexes composed of redox-active (i.e., redox non-innocent) ligands as a charge storage material. The flow battery can include an anode portion and a cathode portion each containing the metal complexes composed of redox-active ligands.

As used herein, metals are defined as any elements on the periodic table that can form bonds to redox-active ligands. These are generally found in the alkali series, alkaline earth series, transition series, main group series, lanthanide series, and the actinide series. Metals defined herein might also include elements called metals, semimetals, and non-metals.

In another embodiment, the present disclosure provides a flow battery including 1) an electrochemical cell having an anode portion, a cathode portion and a separator disposed between the anode portion and the cathode portion; 2) an anode electrode disposed in the anode portion; and 3) a cathode electrode disposed in the cathode portion. Each of the anode portion and the cathode portion includes one or more metals complexed by one or more redox-active ligands. In an embodiment, the metal complexed by one or more redox-active ligands of each of the anode portion and the cathode portion are a similar material. The anode electrode and the cathode electrode can each be connected to a load. The flow battery can include an anode reservoir coupled to the anode portion of the cell and a cathode reservoir coupled to the cathode portion.

As used herein, a separator can be any material separating the anode and cathode chambers and is used to segregate the redox-active material while allowing charge balance to occur during charging and discharging of the battery. In an embodiment, the separator can be a membrane.

In an alternative embodiment, the present disclosure provides a method for generating power. The method comprises introducing one or more metals complexed by one or more redox-active ligands into at least one of an anode portion and a cathode portion of an electrochemical cell and charging or discharging the cell. Introducing may include bringing the metal complexed by one or more redox-active ligands into each of the anode portion and the cathode portion of the electrochemical cell.

In an embodiment, the metal complexed by one or more redox-active ligands introduced into the anode portion is similar to the metal complexed by one or more redox-active ligands introduced into the cathode portion.

In yet another embodiment, the present disclosure provides a flow battery including an electrolyte of one or more aqueous or non-aqueous metals complexed by one or more redox-active ligands. The flow battery includes an anode portion and a cathode portion each containing a portion of the electrolyte.

An advantage of the present disclosure is to provide improved flow batteries.

Another advantage of the present disclosure is to provide an improved method and device for generating power.

Additional features and advantages are described herein, and will be apparent from the following Detailed Description and the figures.

### BRIEF DESCRIPTION OF THE DRAWINGS

FIG. 1 shows a schematic side view representation of a flow battery at discharge in an embodiment of the present disclosure.

FIG. 2 shows a schematic side view representation of a flow battery at discharge in another embodiment of the present disclosure.

FIG. 3 shows examples of metals and ligands in an embodiment of the present disclosure.

FIG. 4 shows mass spectra of 1a (a) and 1b (b) in negative mode. For 1a, the most abundant peaks are observed at 330.8 m/z and 544.9 m/z, which correspond to a fragmentation product, [V(mnt)₂]⁻ and ([NMe₄][V(mnt)₃])⁻. For 1b, the most abundant peaks are observed at m/z=330.8 and 601.0, which correspond to the fragmentation products, [(V(mnt)₂]⁻ and ([NEt₄][V(mnt)₃])⁻.

FIG. 5 shows UV-vis spectra of both a freshly prepared solution of 1a in acetonitrile (solid line) and a solution of 1a that was stored under air for one week (dashed line).

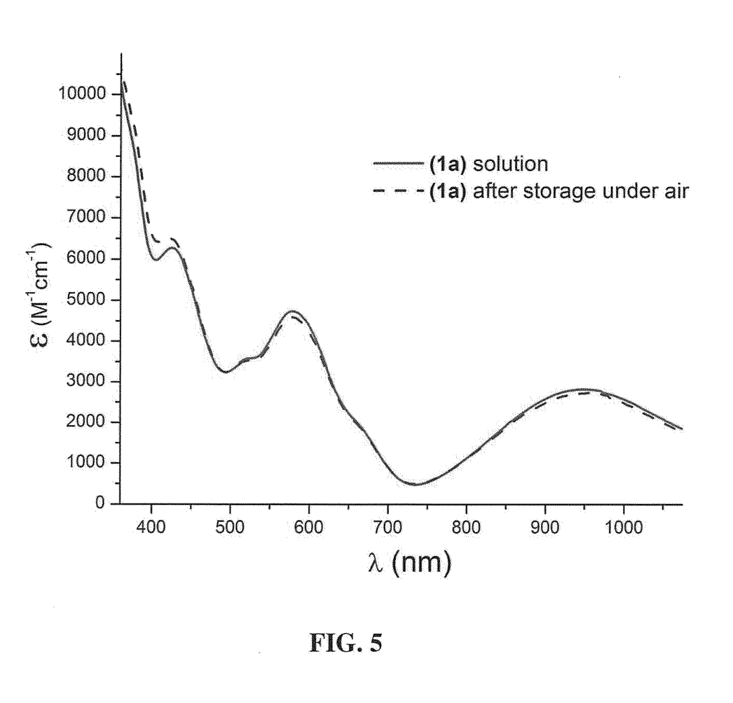

FIG. 6 shows cyclic voltammetry of a freshly prepared solution of (1a) in acetonitrile and a solution that was stored under air for one week, followed by purging with nitrogen before analysis (normalized currents).

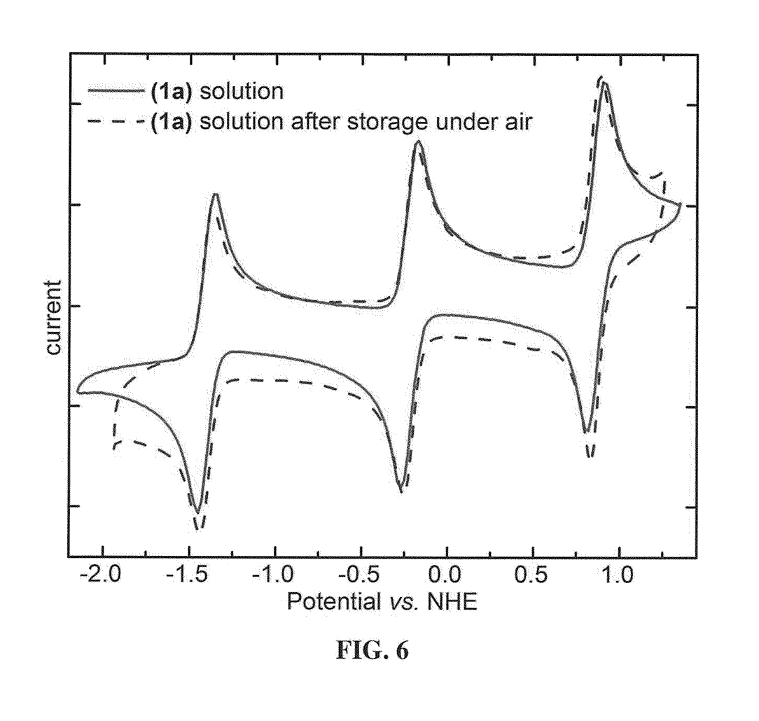

FIG. 7 shows cyclic voltammetry of 1b (20 mM in CH₃CN with 0.1 M [TBA][PF₆]) at a scan rate of 250 mV/s, at room temperature. Vertical hash denotes the approximate OCP prior to scans.

FIG. 8 shows in (a) voltage profiles of a static cell containing 20 mM 1b, in CH₃CN with 0.1 M [TBA][PF₆] supporting electrolyte. Charge (dashed) and discharge (solid) cycles were carried out at 1 mA and 0.1 mA, respectively, between 0 to 2V (cycles two (blue) and 16 (red) are shown), and in (b) Faradaic efficiency (“electrochemical yield”) and coulombic efficiency of the cell described above.

### DETAILED DESCRIPTION

The expanded electrochemical window in non-aqueous systems for flow batteries is constrained by limitations on the redox activity of the complexes in question. Changes in the oxidation state of the transition metal can lead to drastic changes in the preferred coordination geometry and bonding between a metal and its ligands. The current paradigm has been to augment the metal-centered redox events through ligand choice, stabilizing the metal center in the highly reduced, highly oxidized, or generally unstable oxidation states. Additionally, the number of electrons each complex can reversibly store is another limitation that cannot be sufficiently increased by using redox-inactive supporting ligands. As used herein, “complex” refers to a state of being chemically bonded.

Redox “non-innocence” is a term that refers to the ability of a ligand, bound to a transition metal, to undergo oxidation and reduction separate from the metal center of the complex. These ligands are also referred to as redox-active, but as used herein, either of the terms redox-active or non-innocent may be used throughout as equivalent. The term “redox non-innocent” was invented to describe the ambiguities of transition metal oxidation states that arose when certain ligands were bound to transition metals. It became apparent in certain cases that the metal center was not being reduced or oxidized, and instead, the ligands themselves were responsible for the redox behavior of the complex. It should be noted that redox-active ligands can behave in both a supporting role and in a redox-active role, and this dichotomy led to further confusion surrounding the electronic structure of the ligand-metal complex. Certain ligand classes have been studied in depth and deemed redox-active due to their proclivity toward redox-activity. Those ligand types include but are not limited to nitrosyl, α-diimines, α-diketones, α-dithiolenes, bipyridines, terpyridines, catechols, phenolates and tetrapyrrole macrocycles.

As used herein, redox-active ligand complexes of transition metals are seen as a pathway to improved flow battery electrolytes. Because the complex no longer relies on the metal center for all redox activity, the stability of the electrolyte will be enhanced. When compared to a standard coordination compound with only metal-based redox behavior, the incorporation of redox-active ligands increases the energy-to-mass ratio by adding additional ligand-based redox events and making better use of the entire mass of the transition metal complex for energy storage. Additionally, a large electrochemical window of 2 volts or greater will be accessible. Finally, multiple electron redox events at the same potential are possible with several of these ligand systems, increasing the energy density of the system.

As used herein, the terms “one or more metals complexed by one or more redox-active ligands” and “a redox-active ligand coordination complex” are interchangeable. The metals described herein may include, but not be limited to, elements in the first row transition series and other low-cost early transition metals: scandium, titanium, vanadium, chromium, manganese, iron, cobalt, nickel, copper, zinc, zirconium, niobium, molybdenum, hafnium, tantalum, and tungsten.

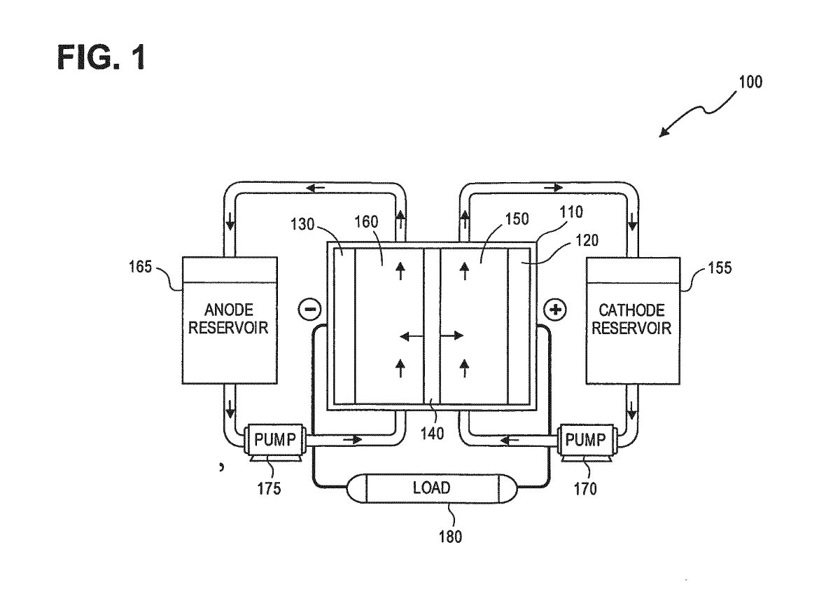

FIG. 1 shows a schematic side view of a flow battery in an embodiment of the present disclosure. Referring to FIG. 1, flow battery 100 includes cell 110 including cathode portion 150 and anode portion 160 separated by separator 140. Disposed in cathode portion 150 is electrode 120 and disposed in anode portion 160 is electrode 130. Electrode 120 and electrode 130 are connected to opposite sides of load 180.

Connected to cathode portion 150 is cathode reservoir 155. Connected to anode portion 160 of cell 110 is anode reservoir 165. Cathode reservoir 155 contains an electrolyte that is pumped by pump 170 through cathode portion 150 of cell 110. Anode reservoir 165 similarly contains an electrolyte that is pumped by pump 175 through anode portion 160. The electrolytes associated with cathode reservoir 155 and anode reservoir 165 act as energy carriers that are pumped simultaneously through cathode portion 150 and anode portion 160, respectively.

The designations for anode and cathode in FIG. 1 are arbitrary and are interchangeable when the charge and discharge cycles are run sequentially. The anode side during a charge cycle becomes the cathode side during a discharge cycle and vice versa.

In charging, the electrical energy supplied causes a chemical reduction reaction in one electrolyte and an oxidation reaction in the other. Separator 140 between cathode portion 150 and anode portion 160 inhibits the electrolytes from mixing but allow selected ions to pass through to complete the oxidation/reduction (redox) reaction. On discharge, the chemical energy contained in the electrolyte is released in the reverse reaction and electrical energy can be drawn from electrode 120 and electrode 130. When in use, the electrolytes are typically continuously pumped in a circuit between cell 110 and the respective reservoirs (cathode reservoir 155 and anode reservoir 165).

In an embodiment, one or more metals complexed by one or more redox-active ligands (e.g., a redox-active ligand coordination complex) as described herein is used as the electrolyte for one or both of the anode portion and cathode portion of flow battery 100. For example, cathode reservoir 155 can contain a redox-active ligand coordination complex and anode reservoir 165 can similarly contain a redox-active ligand coordination complex. The redox-active ligand coordination complex used in cathode portion 150 may be different from the redox-active ligand coordination complex used in anode portion 160.

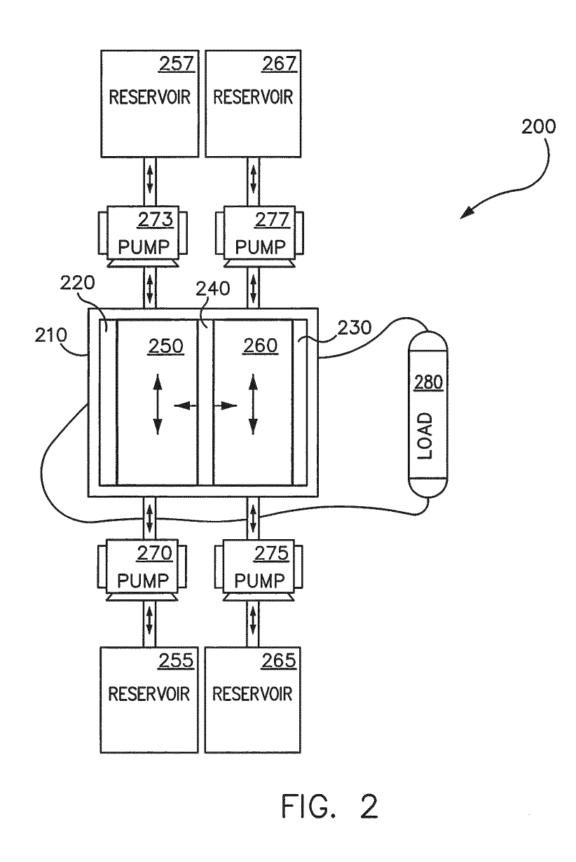

FIG. 2 shows a schematic side view of a flow battery in another embodiment of the present disclosure. Referring to FIG. 2, flow battery 200 includes cell 210 including cathode portion 250 and anode portion 260 separated by separator 240. Disposed in cathode portion 250 is electrode 220 and disposed in anode portion 260 is electrode 230. Electrode 220 and electrode 230 are connected to opposite sides of load 280.

Connected to cathode portion 250 are two cathode reservoirs 255 and 257. Connected to anode portion 260 of cell 210 are reservoirs 265 and 267. Reservoirs 255 and 257 contain an electrolyte that is pumped by pumps 270 and 273 through cathode portion 250 of cell 210. Reservoirs 265 and 267 similarly contain an electrolyte that is pumped by pumps 275 and 277 through anode portion 260. The electrolytes associated with the pairs of reservoirs 255 and 257 and the other pair of reservoirs 265 and 267 act as energy carriers that are pumped simultaneously through cathode portion 250 and anode portion 260, respectively. Before a charge/discharge cycle occurs, the starting state is to have one reservoir of the pair full and the other empty (255 and 265 are full and 257 and 267 are empty). During the first half of a charge/discharge cycle, the electrolyte is pumped from the full reservoir, through the cathode or anode portion, and into the other corresponding empty reservoir (255 pumped into 257 and 265 pumped into 267). The other half of the charge/discharge cycle is completed when the electrolyte is pumped in the reverse direction, out of the reservoir (257 or 267), through the anode or cathode portion, and back into the starting reservoir.

The designations for anode and cathode in FIG. 2 are arbitrary and are interchangeable when the charge and discharge cycles are run sequentially. The anode side during a charge cycle becomes the cathode side during a discharge cycle and vice versa.

In charging, the electrical energy supplied causes a chemical reduction reaction in one electrolyte and an oxidation reaction in the other. Separator 240 between cathode portion 250 and anode portion 260 inhibits the electrolytes from mixing but allow selected ions to pass through to complete the oxidation/reduction (redox) reaction. On discharge, the chemical energy contained in the electrolyte is released in the reverse reaction and electrical energy can be drawn from electrode 220 and electrode 230. When in use, the electrolytes are typically continuously pumped in a circuit between cell 210 and the respective reservoirs (cathode reservoirs 255 and 257 and anode reservoirs 265 and 267).

In an embodiment, a redox-active ligand coordination complex as described herein is used as the electrolyte for one or both of the anode portion and cathode portion of flow battery 200. For example, cathode reservoirs 255 and 257 can contain a redox-active ligand coordination complex and anode reservoirs 265 and 267 can similarly contain a redox-active ligand coordination complex. The redox-active ligand coordination complex used in cathode portion 250 may be different from the redox-active ligand coordination complex used in anode portion 260.

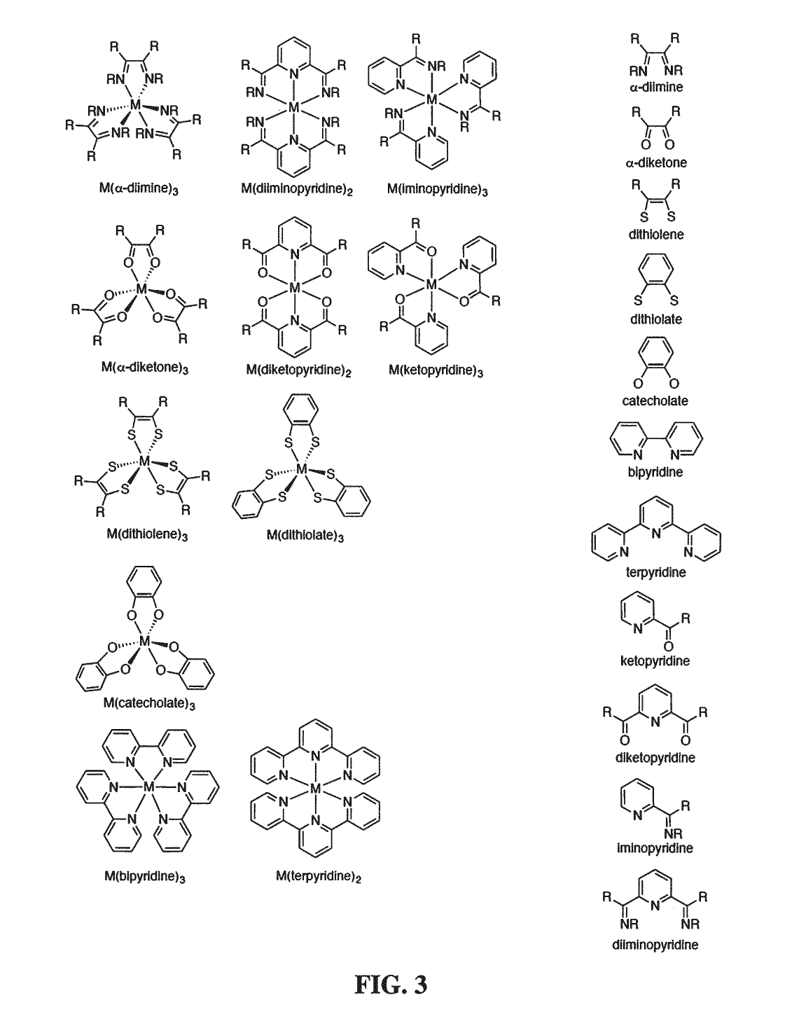

Representative redox-active ligand coordination complexes suitable as an electrolyte include, but are not limited to, those containing any metals of the transition metal series and ligands such as nitrosyl, α-diimines, α-diketones, α-dithiolenes, bipyridines, terpyridines, catechols, phenolates and tetrapyrrole macrocycles. Non-limiting examples of metals and ligands are shown in FIG. 3.

### EXAMPLES

By way of example and not limitation, the following examples are illustrative of various embodiments of the present disclosure.

### Example 1

### Application of Redox Non-Innocent Ligands to Non-Aqueous Flow Battery Electrolytes

### Physical Methods

Mass spectrometry was carried out in methanol with a Waters LCT Premier XE using electrospray ionization (ESI) coupled to a time-of-flight (TOF) detector. UV-vis spectroscopy was performed with a Unico SQ-3802 Scanning UV/visible Spectrophotometer.

Crystal structure was determined using standard literature methods and information was collected on a SuperNova diffractomer (Oxford Diffraction). The X-ray source was monochromated 0.71073 Å Mo-Kα radiation and the data was integrated and corrected for absorption using the CrysAlisPro software package (Oxford Diffraction, Ltd.).

Cyclic voltammetry (CV) was carried out using a Bio-Logic SP-200 potentiostat, a glassy carbon working electrode, a Pt wire counter electrode and a silver-wire pseudo reference electrode. Ferrocene was used as an internal standard. For static cell battery testing, an H-cell was used containing 20 mM anolyte/catholyte and 100 mM [NBu₄][PF₆] supporting electrolyte. Charge and discharge currents were 1 mA and 0.1 mA, respectively. Graphite electrodes (POCO) having a 2 cm² active area and a Tonen V25EKD separator were used.

### Synthesis and Characterization of 1a and 1b

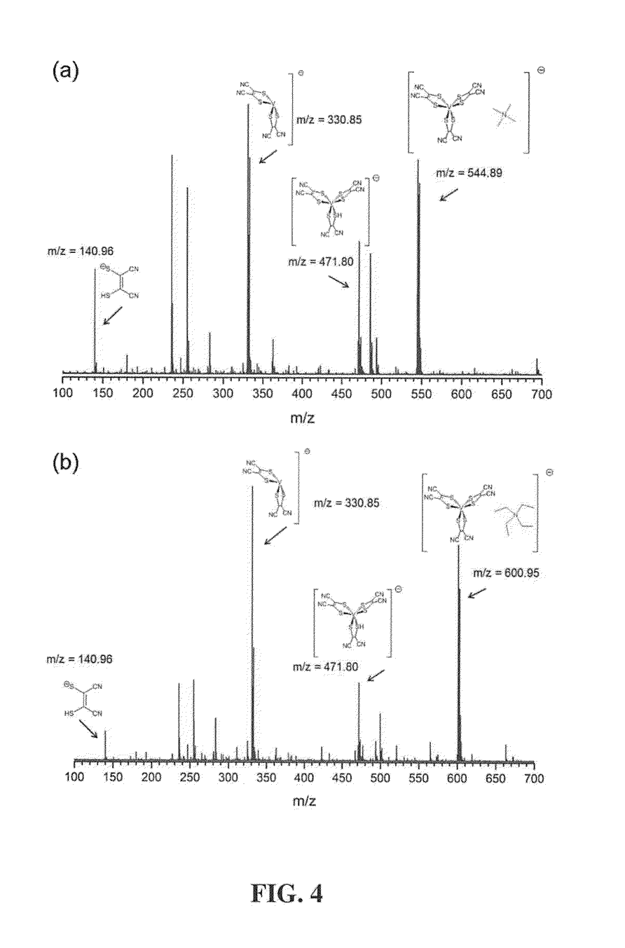

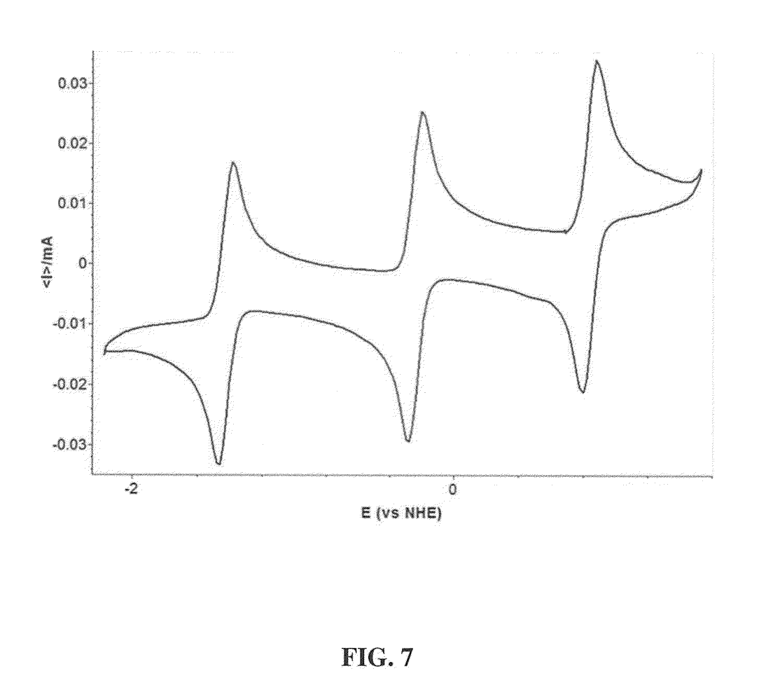

Tetramethyl- and tetraethylammonium salts of [V(mnt)₃]²⁻ were synthesized according to A. Davison, N. Edelstein, R. H. Holm, A. H. Maki, J. Am. Chem. Soc. 1964, 86, 2799, and they demonstrated electrochemistry matching that reported in the literature (FIG. 7) and appropriate mass spectrometry (FIG. 4). Subsequently, 1a was synthesized in 94% yield in the following manner. The isolated material was analytically identical to that reported previously. VCl₄.2THF was first prepared by drop-wise addition of THF (5 mL, 62 mmol) to a cooled solution of VCl₄ (0.5 g, 3 mmol) in dichloromethane (10 mL), and the resulting purple solid was isolated by filtration. A solution of 0.188 g (0.558 mmol) VCl₄.2THF in 5 mL THF was then added to a suspension of 0.312 g (1.67 mmol) disodium maleonitrile in 10 mL THF. After one hour, a solution of 0.122 g (1.16 mmol) tetramethylammonium chloride in 1 mL ethanol was added. The solution was stirred overnight, after which time an off-white solid was removed by filtration and discarded. The filtrate was evaporated to dryness and then dissolved in ˜20 mL acetone. The addition of 80 mL of chloroform caused the product to precipitate as black crystals. Isolation by filtration yielded 0.325 g (0.524 mmol) of black crystals. Further purification was effected by addition of approximately two volumes of 2-propanol to a saturated solution of 1a in acetone.

### Determination of Solubility of 1a and 1b in Acetonitrile

The solubility of 1a and 1b in acetonitrile were determined using UV-vis spectroscopy. Solutions were prepared by mixing roughly equal volumes of metal complex and solvent. The resulting black solution was concentrated with a stream of N₂ until a slight crust began to form, which was re-dissolved with warming and agitation. The sample was then centrifuged at 8000 RPM for two hours and allowed to stand overnight. Concentrations were determined using absorbance at 568 nm, ε₅₆₈=4540 M⁻¹cm⁻¹.

### Results and Analysis

The following discussion provides details of a new, non-aqueous RFB electrolyte based on tetramethyl- and tetraethylammonium salts of tris(mnt)vanadium(IV) ([V(mnt)₃]²⁻; mnt=(NC)₂C₂S₂²⁻), 1a and 1b, respectively, including their battery performance in a static (i.e., non-flowing) cell. The dithiolate ligands in this complex have been previously demonstrated to be “redox non-innocent ligands” (NIL), as they are known to participate in electrochemical events separate from those of the vanadium center.

It was first recognized through electron paramagnetic resonance spectroscopy in the 1960s that the singly occupied molecular orbital (MO) in [V(mnt)₃]⁰ is ligand-based. This fact was recently elaborated upon, whereby a suite of spectroscopic and computational methods unambiguously demonstrated that sequential one-electron reductions of [V(mnt)₃]²⁻ add electrons to the metal center, but one-electron oxidation removes an electron from the ligands, yielding an antiferromagnetically coupled, singlet-diradical ground state for [V(mnt)₃]¹⁻. This ligand-based, redox activity is a powerful approach to increasing the charge storage capacity of RFB electrolytes. In contrast to ligands in conventional transition metal complexes, NIL may be used as reservoirs for additional redox equivalents, improving energy density for a given electrolyte concentration. Furthermore, oxidative and reductive decomposition of complexes may be mitigated when electrons are transferred to and from MOs derived from ligand-π systems rather than those that are involved in metal-ligand bonding.

A significant dependence of the redox potential of one of the three redox couples of [V(mnt)₃]²⁻ on the cation used in the supporting electrolyte is also discussed, highlighting the importance of the counter ion in optimizing the open circuit potential (OCP) of RFBs based on this class of compounds.

CV of 1b, shown in FIG. 7, is similar to that reported previously for [V(mnt)₃]²⁻ with various cations. Three reversible waves corresponding to the 4⁻/3⁻, 3⁻/2⁻ and 2⁻/1⁻ redox couples are observed at −1.41 V, −0.227 V and 0.856 V vs. SHE, respectively. Redox potential values reported herein correspond to the mid-point between the anodic and cathodic peak potentials of a cyclic voltammogram. The maximum solubility of both 1a and 1b was spectroscopically determined to be ˜0.9M using Beers law. Thus, a battery cell constructed using 1 as both anolyte and catholyte has a theoretical cell potential of 1.1 V and a theoretical energy density of 13 W·h·L⁻¹. However, bulk reduction of [V(mnt)₃]²⁻ to [V(mnt)₃]³⁻ in the anodic half-cell before charging would result in a theoretical cell potential and energy density of 2.3V and 28 W·h·L⁻¹, respectively. These values compare favorably to previously reported non-aqueous RFB electrolytes. A RFB based on [V(mnt)₃]²⁻ solutions would also benefit from having the same chemical species in both half-cells, a strategy that has been employed previously to prevent irreversible self-discharge from crossover of active redox species through the membrane. This feature then also enables the use of inexpensive, microporous separators that are not ion-selective.

A two-compartment cell with non-flowing solutions (i.e., “static cell”) was assembled to assess the charge-discharge characteristics of [V(mnt)₃]²⁻ in a non-aqueous environment. Both compartments contained a 20 mM solution of 1b in acetonitrile with 0.1 M tetrabutylammonium hexafluorophosphate as supporting electrolyte. Two graphite electrodes (POCO) with 2 cm² active areas and a V25EKD separator (Tonen) were used. Because the discharged cathode and anode complexes are both in the 2⁻ oxidation state, it is presumed that the cathode complex converts to the 1⁻ state and the anode complex converts to the 3⁻ state during charge. As such, an OCP or equilibrium cell potential of 1.1V at 50% state-of-charge is expected, based on CV experiments (FIG. 7).

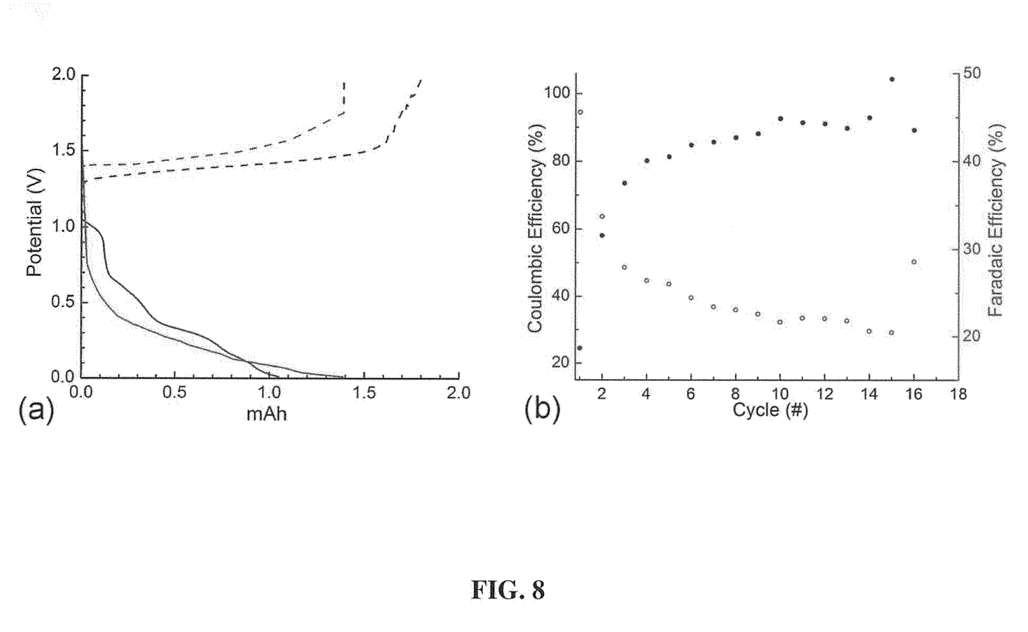

Galvanostatic cycling of the static cell was performed, and the results are shown in FIG. 8a. Cycles 2 and 16 both show a flat charging plateau slightly above the expected equilibrium cell potential. The capacity during the charge cycles is observed to decrease ˜20% from cycle 2 to cycle 16. The observed discharge voltage gradually decreased from just below the equilibrium cell potential to 0 V. Likely causes for these features include ohmic losses, the small separator area between the half-cells, and a relatively large distance between electrodes. Electrochemical yield, or faradaic efficiency, of the charge cycles was observed initially at ˜45% and decreased to stabilize at ˜20-25% through cycle 16 (FIG. 8b). Possible sources of loss include irreversible side reactions, crossover of charged species through the separator and mass transport limitations. The coulombic efficiency stabilizes at ˜90% by cycle 5 (FIG. 8b) which compares favorably to other non-aqueous RFB systems. Recovery of such a large fraction of current upon discharge suggests the possibility of a high-efficiency RFB upon optimization.

Long-term stability is a key consideration in the development of RFB systems and recent research has included extensive investigations of state-of-the-art aqueous RFB systems. Factors affecting stability and the decay of capacity including membrane chemistry, thermal effects, gas evolution and electrode corrosion have been identified and this remains an active research area. In comparison, the long-term stability of non-aqueous RFBs remains to be investigated. In the present case, as prepared 1a is stable to ambient oxygen and moisture, and no decomposition was observed when it is stored under air. To investigate its stability in solution, a 1 mM acetonitrile solution was analyzed, stored for a period of one week under air atmosphere, and subsequently analyzed. Both CV and UV-vis spectroscopy were unchanged suggesting that no decomposition occurs on this time-scale. Long-term studies to investigate the stability of the membrane, electrode and electrolytes have been initiated.

### CONCLUSION

These studies have demonstrated a non-aqueous RFB electrolyte based on the alkylammonium salts of a vanadium tris(dithiolene) compound, in which equivalents of charge are stored on the ligands in addition to the metal center. In the overall 2-oxidation state, these compounds are insensitive to ambient oxygen and moisture in both the solid state, and an acetonitrile solution. This strategy has the potential to greatly improve the energy density of transition-metal based RFB electrolytes. An improved procedure for synthesizing these compounds in very high yields has been developed, facilitating scale-up.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

In the description above, for the purposes of explanation, numerous specific details have been set forth in order to provide a thorough understanding of the embodiments. It will be apparent however, to one skilled in the art, that one or more other embodiments may be practiced without some of the specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. A flow battery comprising one or more metals complexed by one or more redox-active ligands.

2. The flow battery of claim 1, wherein the metal is a type selected from the group consisting of alkali series, alkaline earth series transition series, main group series, lanthanide series, the actinide series, and combinations thereof.

3. The flow battery of claim 1, wherein the metal is complexed by a combination of non-redox-active ligands and redox-active ligands.

4. The flow battery of claim 1, wherein the flow battery comprises an anode portion and a cathode portion each including the metal complexed by one or more redox-active ligands.

5. The flow battery of claim 1, wherein the redox-active ligands are selected from the group consisting of nitrosyl, α-diimines, α-diketones, α-dithiolenes, bipyridines, terpyridines, catechols, phenolates, tetrapyrrole macrocycles and combinations thereof.

6. A flow battery comprising:
an electrochemical cell comprising an anode portion, a cathode portion and a separator disposed between the anode portion and the cathode portion, wherein each of the anode portion and the cathode portion comprises one or more metals complexed by one or more redox-active ligands;
an anode electrode disposed in the anode portion; and
a cathode electrode disposed in the cathode portion.

7. The flow battery of claim 6, wherein the metal is a type selected from the group consisting of alkali series, alkaline earth series transition series, main group series, lanthanide series, the actinide series, and combinations thereof.

8. The flow battery of claim 6, wherein the metal complexed by one or more redox-active ligands of each of the anode portion and the cathode portion are a similar material.

9. The flow battery of claim 6, wherein the anode electrode and the cathode electrode are each connected to a load.

10. The flow battery of claim 6, further comprising an anode reservoir coupled to the anode portion of the cell and a cathode reservoir coupled to the cathode portion.

11. The flow battery of claim 6, wherein the redox-active ligands are selected from the group consisting of nitrosyl, α-diimines, α-diketones, α-dithiolenes, bipyridines, terpyridines, catechols, phenolates, tetrapyrrole macrocycles and combinations thereof.

12. A method comprising:
introducing one or more metals complexed by one or more redox-active ligands into at least one of an anode portion and a cathode portion of an electrochemical cell; and
charging or discharging the cell.

13. The method of claim 12, wherein introducing comprises bringing the metal complexed by one or more redox-active ligands into each of the anode portion and the cathode portion of the electrochemical cell.

14. The method of claim 12, wherein the metal complexed by one or more redox-active ligands introduced into the anode portion is similar to the metal complexed by one or more redox-active ligands introduced into the cathode portion.

15. The method of claim 12, wherein the redox-active ligands are selected from the group consisting of nitrosyl, α-diimines, α-diketones, α-dithiolenes, bipyridines, terpyridines, catechols, phenolates, tetrapyrrole macrocycles and combinations thereof.

16. The method of claim 12, wherein the metal is a type selected from the group consisting of alkali series, alkaline earth series transition series, main group series, lanthanide series, the actinide series, and combinations thereof.

17. A flow battery comprising an electrolyte of an aqueous or non-aqueous solution including one or more metals complexed by one or more redox-active ligands.

18. The flow battery of claim 17, wherein the flow battery comprises an anode portion and a cathode portion each including a portion of the electrolyte.

19. The flow battery of claim 17, wherein the redox-active ligands are selected from the group consisting of nitrosyl, α-diimines, α-diketones, α-dithiolenes, bipyridines, terpyridines, catechols, phenolates, tetrapyrrole macrocycles and combinations thereof.
